(19) United States
(12) Patent Application Publication
(10) Pub. No.: US 2025/0068938 A1
(43) Pub. Date: Feb. 27, 2025

(54) METHOD AND APPARATUS WITH NEURAL NETWORK DEVICE PERFORMANCE AND POWER EFFICIENCY PREDICTION

(71) Applicants: Samsung Electronics Co., Ltd., Suwon-si (KR); Seoul National University R&DB Foundation, Seoul (KR)

(72) Inventors: Minje KIM, Suwon-si (KR); Jaejin LEE, Seoul (KR); Dohun KIM, Suwon-si (KR); Jinpyo KIM, Seoul (KR); Soon-Wan KWON, Suwon-si (KR); Heehoon KIM, Seoul (KR); Daeyoung PARK, Seoul (KR)

(73) Assignees: Samsung Electronics Co., Ltd., Suwon-si (KR); Seoul National University R&DB Foundation, Seoul (KR)

(21) Appl. No.: 18/426,830

(22) Filed: Jan. 30, 2024

(30) Foreign Application Priority Data
Aug. 22, 2023 (KR) 10-2023-0110052

(51) Int. Cl. G06N 5/022; G06F 1/3203; G06N 3/04

(52) U.S. Cl. CPC G06N 5/022; G06F 1/3203; G06N 3/04

(57) ABSTRACT

A processor-implemented method includes obtaining a benchmark execution result, receiving input data comprising a neural network model subject to prediction and analysis requirement information, receiving information on hardware of a device in which the neural network model is run, building a prediction model based on the benchmark execution result and the hardware information, extracting layer information respectively corresponding to a plurality of layers configuring the neural network model, and predicting either one or both of operation performance information and energy efficiency information respectively corresponding to the plurality of layers by inputting the analysis requirement information and the layer information to the prediction model.

### CROSS-REFERENCE TO RELATED APPLICATIONS

This application claims the benefit under 35 USC § 119 (a) of Korean Patent Application No. 10-2023-0110052, filed on Aug. 22, 2023 in the Korean Intellectual Property Office, the entire disclosure of which is incorporated herein by reference for all purposes.

### BACKGROUND

### 1. Field

The following description relates to a method with neural network device performance and power efficiency prediction.

### 2. Description of Related Art

Deep learning may include an architecture based on an algorithm set to model high-level abstraction from input data using a deep graph having multiprocessing layers. Various node layers and parameters may be included in a deep learning architecture. For example, in the deep learning architecture, a convolutional neural network (CNN) may be used in various artificial intelligence and machine learning applications, such as image classification, image caption generation, visual question and answer, and autonomous driving vehicles.

A neural network system described above may have high complexity because various parameters are included therein and numerous operations are required to classify an image, and may significantly consume resources and power. Accordingly, a method may not efficiently perform operations to implement the neural network system, more particularly, for example, the method may not increase operation efficiency in a mobile environment in which limited resources are provided.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: obtaining a benchmark execution result; receiving input data comprising a neural network model subject to prediction and analysis requirement information; receiving information on hardware of a device in which the neural network model is run; building a prediction model based on the benchmark execution result and the hardware information; extracting layer information respectively corresponding to a plurality of layers configuring the neural network model; and predicting either one or both of operation performance information and energy efficiency information respectively corresponding to the plurality of layers by inputting the analysis requirement information and the layer information to the prediction model.

The predicting may include predicting the operation performance information and the energy efficiency information respectively corresponding to the plurality of layers for each component configuring the device.

The predicting may include: for each of the plurality of layers, determining a weight between a computation amount and a memory access amount in a layer; and predicting the operation performance information and the energy efficiency information respectively corresponding to the plurality of layers based on the weight.

The predicting may include: classifying the plurality of layers into either one of a compute-bound layer and a memory-bound layer; and predicting the operation performance information and the energy efficiency information respectively corresponding to the plurality of layers based on a result of the classifying.

The extracting of the layer information may include extracting input data information and output data information respectively corresponding to the plurality of layers.

The obtaining of the benchmark execution result may include: receiving user setting information; generating a benchmark based on the user setting information; and generating the benchmark execution result by executing the benchmark.

The receiving of the user setting information may include receiving information on a preset operating frequency, information on a neural network model subject to benchmark, and information on a component configuring the device.

The generating of the benchmark may include, for each of the plurality of layers configuring the neural network model subject to the benchmark, generating the benchmark based on an input data size and an operating frequency of a layer.

The generating of the benchmark may include generating the benchmark based on a kernel corresponding to a component configuring the device.

The generating of the benchmark execution result may include: performing a first measurement on operation performance and energy efficiency corresponding to the benchmark based on an application programming interface (API); performing a second measurement on operation performance and energy efficiency corresponding to the benchmark using an external device; and performing consistency determination on the benchmark execution result by comparing a result of the first measurement and a result of the second measurement.

In one or more general aspects, a non-transitory computer-readable storage medium may store instructions that, when executed by one or more processors, configure the one or more processors to perform any one, any combination, or all of operations and/or methods described herein.

In one or more general aspects, an apparatus includes: one or more processors configured to: obtain a benchmark execution result; receive input data comprising a neural network model subject to prediction and analysis requirement information; receive information on hardware of a device in which the neural network model is run; build a prediction model based on the benchmark execution result and the hardware information; extract layer information respectively corresponding to a plurality of layers configuring the neural network model; and predict either one or both of operation performance information and energy efficiency information respectively corresponding to the plurality of layers by inputting the analysis requirement information and the layer information to the prediction model.

For the predicting, the one or more processors may be configured to predict the operation performance information and the energy efficiency information respectively corresponding to the plurality of layers for each component configuring the device.

For the predicting, the one or more processors may be configured to: for each of the plurality of layers, determine a weight between a computation amount and a memory access amount in a layer; and predict the operation performance information and the energy efficiency information respectively corresponding to the plurality of layers based on the weight.

For the predicting, the one or more processors may be configured to: classify the plurality of layers into a compute-bound layer or a memory-bound layer; and predict the operation performance information and the energy efficiency information respectively corresponding to the plurality of layers based on a classification result.

For extracting of the layer information, the one or more processors may be configured to extract input data information and output data information respectively corresponding to the plurality of layers.

For the obtaining of the benchmark execution result, the one or more processors may be configured to: receive user setting information; generate a benchmark based on the user setting information; and generate the benchmark execution result by executing the benchmark.

For the receiving of the user setting information, the one or more processors may be configured to receive information on a preset operating frequency, information on a neural network model subject to benchmark, and information on a component configuring the device.

For the generating of the benchmark, the one or more processors may be configured to, for each of the plurality of layers configuring the neural network model subject to the benchmark, generate the benchmark based on an input data size and an operating frequency of a layer.

For the generating of the benchmark execution result, the one or more processors may be configured to: perform a first measurement on performance and energy efficiency; perform a second measurement on operation performance and energy efficiency corresponding to the benchmark using an external device; and perform consistency determination on the benchmark execution result by comparing a result of the first measurement and a result of the second measurement.

Other features and aspects will be apparent from the following detailed description, the drawings, and the claims.

### BRIEF DESCRIPTION OF THE DRAWINGS

FIG. 1 illustrates an example of a prediction apparatus according to one or more embodiments.

FIG. 2 illustrates an example of a prediction system according to one or more embodiments.

FIG. 3 illustrates an example of an operation of predicting a graphics processing unit (GPU) power and performance by building a GPU power and performance prediction model when a neural network program is executed by a GPU according to one or more embodiments.

FIG. 4 illustrates an example of an operation of a benchmark driving apparatus according to one or more embodiments.

FIG. 5A illustrates an example of a benchmark generated by a benchmark driving apparatus according to one or more embodiments.

FIGS. 5B and 5C illustrate examples of measuring power consumption and performance with respect to a benchmark according to one or more embodiments.

FIG. 6 illustrates an example of a consistency verification method according to one or more embodiments.

FIG. 7 illustrates an example of a neural network hooking apparatus according to one or more embodiments.

FIG. 8 illustrates an example of an operation of a power and performance prediction apparatus according to one or more embodiments.

FIG. 9 illustrates an example of a method of predicting power consumption of an artificial neural network model according to one or more embodiments.

FIG. 10 illustrates an example of a method of determining an optimal operating frequency according to one or more embodiments.

FIG. 11 illustrates an example of a prediction method according to one or more embodiments.

FIG. 12 illustrates an example of a configuration of an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms used herein including technical or scientific terms have the same meaning as commonly understood by one of ordinary skill in the art to which this disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

The phrases “at least one of A, B, and C,” “at least one of A, B, or C,” and the like are intended to have disjunctive meanings, and these phrases “at least one of A, B, and C,” “at least one of A, B, or C,” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment (for example, as to what an example or embodiment may include or implement) means that at least one example or embodiment exists where such a feature is included or implemented, while all examples are not limited thereto.

The examples may be implemented as various types of products, such as, for example, a personal computer (PC), a laptop computer, a tablet computer, a smart phone, a television (TV), a smart home appliance, an intelligent vehicle, a kiosk, and a wearable device. Hereinafter, examples will be described in detail with reference to the accompanying drawings. In the drawings, like reference numerals are used for like elements.

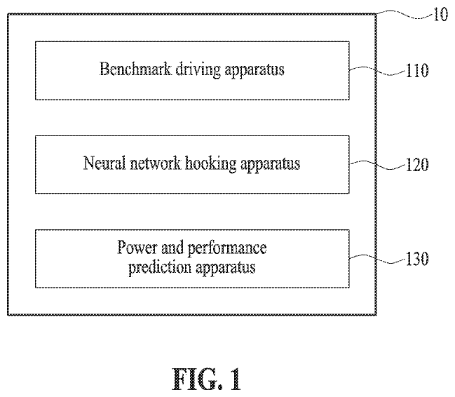

FIG. 1 illustrates an example of a prediction apparatus according to one or more embodiments.

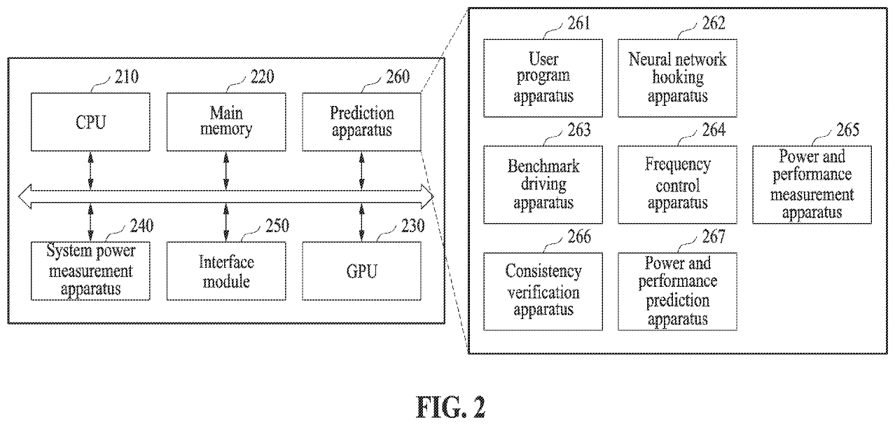

An apparatus and method of one or more embodiments may efficiently perform operations to implement a neural network system, for example, by increasing operation efficiency in a mobile environment in which limited resources are provided. Referring to FIG. 1, a prediction apparatus 10 may include a benchmark driving apparatus 110, a neural network hooking apparatus 120, and a power and performance prediction apparatus 130. However, not all the shown components are essential. The prediction apparatus 10 may be implemented by more components than the illustrated components, and the prediction apparatus 10 may be implemented by fewer components. For example, although a description is provided with reference to FIG. 2, the prediction apparatus 10 may further include a user program, a frequency control apparatus, a power and performance measurement apparatus, and a consistency verification apparatus. Furthermore, although in the drawings, the prediction apparatus 10 is divided into the benchmark driving apparatus 110, the neural network hooking apparatus 120, and the power and performance prediction apparatus 130, in practice, all operations may be performed by one or more processors.

The prediction apparatus 10 may predict the power efficiency and performance of an operation device (e.g., a graphics processing unit (GPU)) when the operation device executes an artificial neural network (ANN) model. Hereinafter, a description is provided based on that the ANN model is executed by a GPU. However, the ANN model may be executed by various operation devices other than a GPU. The ANN model may be referred to as a neural network, an ANN, a neural network model, and a deep neural network (DNN).

The prediction apparatus 10 may collect data on a memory module of a GPU and the power efficiency and performance of each operation module. Specifications of a hardware accelerator to execute an ANN model may be selected and the collected data may be used for designing and developing an accelerator. In addition, when configuring a new neural network structure, a hardware architecture configured to achieve high performance and power efficiency may be secured using data on a property of a collected layer.

Furthermore, when configuring a supercomputer with a large-scale server system accelerated by multiple GPUs or a server system based on a separate acceleration application-specific integrated circuit (ASIC) chip, data obtained by the prediction apparatus 10 may be used as base data. In addition, when exploring a hardware architecture with a new design method, power efficiency and performance data may be collected or predicted using the prediction apparatus 10. Examples of the operating methods of the benchmark driving apparatus 110, the neural network hooking apparatus 120, and the power and performance prediction apparatus 130 are described with reference to FIGS. 2 to 10 shown below.

FIG. 2 illustrates an example of a prediction system according to one or more embodiments.

Referring to FIG. 2, a prediction system according to one or more embodiments may include a central processing unit (CPU) 210, a main memory 220, a GPU 230, a system power measurement apparatus 240, an interface module 250, and a prediction apparatus 260. The description provided with reference to FIG. 1 may also apply to FIG. 2. For example, the prediction apparatus 10 described with reference to FIG. 1 may apply to the prediction apparatus 260 of FIG. 2.

The CPU 210 may control overall operations to drive a neural network model. The CPU 210 may include one processor core or a plurality of processor cores. The CPU 210 may execute programs stored in the main memory 220. The CPU 210 may control the GPU 230, the system power measurement apparatus 240, the interface module 250, and the prediction apparatus 260. In addition, the CPU 210 may perform some operations of a neural network model together with the GPU 230.

Furthermore, although FIG. 2 illustrates that the prediction apparatus 260 is a piece of hardware separated from the CPU 210, the prediction apparatus 260 may be included in the CPU 210 depending on embodiments. For example, an operation performed by the prediction apparatus 260 may be implemented by executing a software program, and the software program may be stored in the main memory 220 and the software program stored in the main memory 220 may be executed by the prediction apparatus 260 included in the CPU 210.

The main memory 220 may store instructions to control a GPU power efficiency measurement and performance prediction apparatus and/or input data and/or output data of the GPU power efficiency and performance prediction apparatus. The main memory 220 may be implemented as a memory, such as dynamic random-access memory (DRAM) and/or static RAM (SRAM).

The GPU 230 may perform various graphic operations. The GPU 230 may have a structure that is advantageous to a parallel operation iteratively processing similar operations. Thus, the GPU 230 may efficiently compute large-scale matrix multiplication and addition operations among operations of a neural network model as well as a graphic operation. The GPU 230 may be configured by one or multiple cores. In addition, the GPU 230 may be configured to minimize data movement as a memory is internally included.

The system power measurement apparatus 240 may be an apparatus for measuring the power consumption of the entire system. The system power measurement apparatus 240 may measure a consumption current, real-time voltage, real-time power, and cumulative power. The system power measurement apparatus 240 may transmit a measurement result to the prediction apparatus 260 and/or may store the measurement result in the main memory 220.

The interface module 250 may perform a communication function with a neural network system and an external host system. Data may be read or written by accessing the main memory 220 through the interface module 250. For example, an interface may be provided to enable a system bus, such as a data bus, an address bus, and a control bus, through an interconnector in the system.

The prediction apparatus 260 may include a user program apparatus 261 (e.g., one or more use program apparatuses), a neural network hooking apparatus 262, a benchmark driving apparatus 263, a frequency control apparatus 264, a power and performance measurement apparatus 265, a consistency verification apparatus 266, and a power and performance prediction apparatus 267. However, as described above, not all the shown components are essential. The prediction apparatus 260 may be implemented by more components than the illustrated components, and the prediction apparatus 260 may be implemented by fewer components.

The user program apparatus 261 may be a device including user setting information, a neural network program, and a benchmark program. The user setting information may include setting data to measure GPU power efficiency and drive the performance prediction apparatus, such as a meta-parameter on a neural network model executing a neural network program, a setting parameter for model driving, and a profile parameter for driving a benchmark program. The neural network program may be a program that trains various neural network models, such as a convolutional neural network (CNN), a recurrent neural network (RNN), and long short-term memory (LSTM) and infers. Both forward pass and backward pass may be executed when training the neural network model and forward pass may be executed when inferring. The benchmark program may be a program that executes kernels and benchmark kernels in a specific unit to collect power consumption or performance for each hardware component of a GPU.

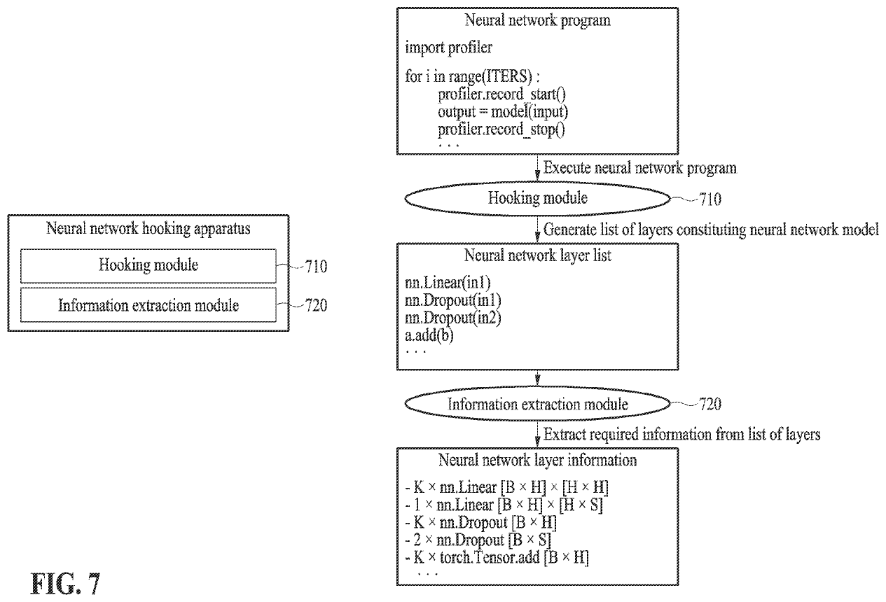

The neural network hooking apparatus 262 may be an apparatus for extracting and storing a property of each layer constituting a model in a neural network model given by a user. The layer property may be a size of an input/output tensor, a data type, various parameters, and forward pass and backward pass information. Not only a model layer provided by a neural network framework but also a neural network layer directly designed by a user may also display hooking information and may extract layer property information. An example of an operating method of the neural network hooking apparatus 262 is described with reference to FIG. 7 shown below.

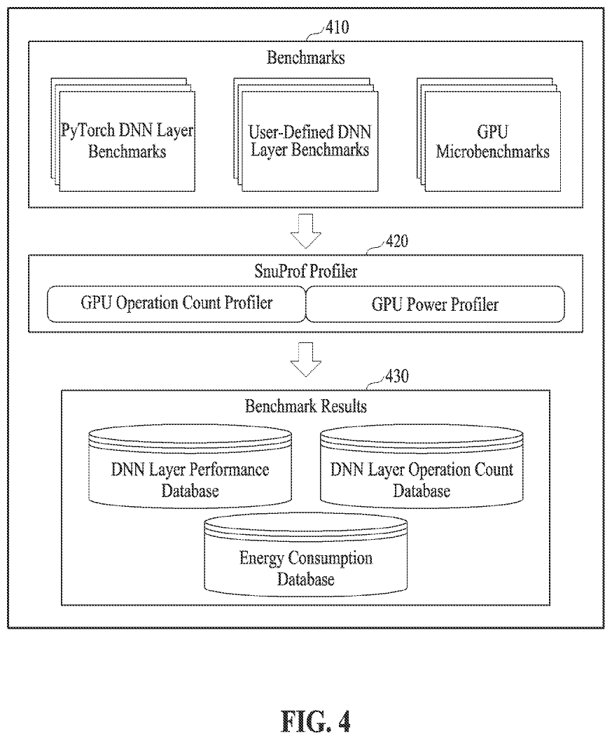

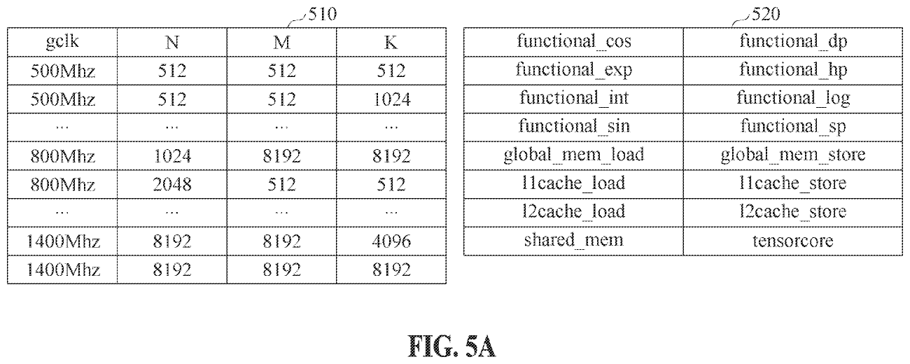

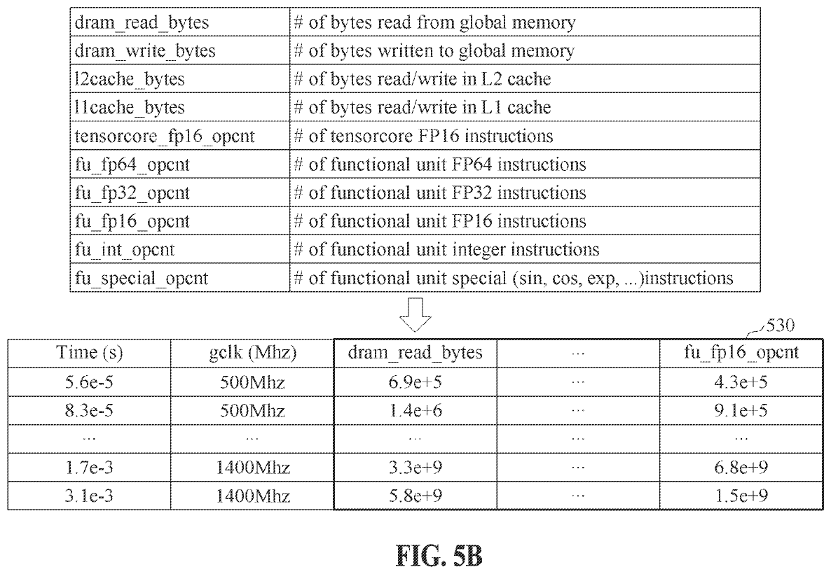

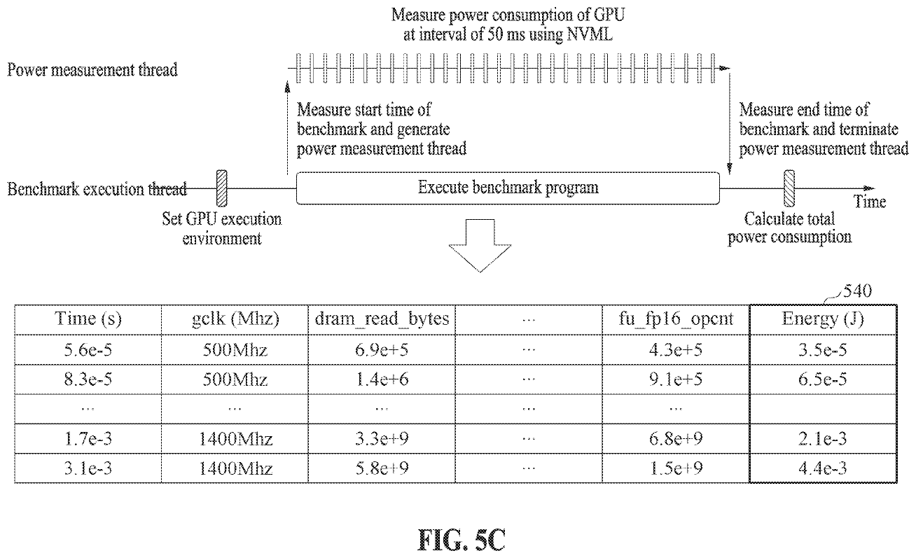

The benchmark driving apparatus 263 may be an apparatus for generating a benchmark reflecting a requirement by a user for each GPU hardware component, executing a benchmark program, and storing an execution result. The benchmark driving apparatus 263 may respectively generate and collect benchmarks of a plurality of layers configuring a neural network. In addition, the benchmark driving apparatus 263 may generate and collect flexible and various benchmarks, such as a benchmark focused on a computational function, a benchmark focused on a memory input/output function, and a benchmark with mixed computation and memory functions. For example, a hardware component performing an operation function of a GPU may be a streaming multiprocessor (SM), a floating point (FP) 16 functional unit (FU), an FP32 FU, an FP64 FU, a special FU, and a tensor core. A hardware component performing a memory input/output function may be a shared memory, an L1 cache, an L2 cache, and a global memory. A benchmark result may be collected by operating a kernel that generates stress to each hardware component. In this case, accuracy may increase by dividing the utilization of the hardware component into various levels. For example, by dividing into four levels, 25%, 50%, 75%, and 100%, the accuracy of a benchmark result of the hardware component may be statistically improved. An example of an operating method of the benchmark driving apparatus 263 is described with reference to FIGS. 4 to 5B shown below.

The frequency control apparatus 264 may be an apparatus for fixing a frequency of a GPU based on configuration information of a user or controlling the frequency to enable comparison between frequencies. The GPU frequency may include a core clock frequency and a memory clock frequency. Since an interval in which a GPU voltage value changes varies by the core clock frequency of each GPU, the frequency control apparatus 264 may find a condition having optimal power effectiveness by changing the GPU frequency. In addition, a memory clock frequency by GPU may be determined based on a core clock frequency, and the frequency control apparatus 264 may determine whether a separate memory clock frequency may be used.

The power and performance measurement apparatus 265 may be an apparatus for measuring the power consumption and performance of a GPU based on a benchmark and user setting information. A GPU may provide an application programming interface to control a GPU driving method by a program by a GPU manufacturer. For example, NVIDIA provides a function to measure and set power, temperature, performance, and the like by providing an NVIDIA management library (NVML). The power and performance measurement apparatus 265 may measure the power consumed by a GPU at a predetermined time point of a benchmark or may calculate (e.g., determine) a total consumed power and an average power of the GPU during a predetermined time interval by using NVML.

The consistency verification apparatus 266 may be an apparatus for determining whether a result value measured by a power and performance measurement apparatus 500 is a normal value or an anomaly. To determine the consistency of the result value measured by the power and performance measurement apparatus 500, the consistency verification apparatus 266 may determine whether the result value measured by the power and performance measurement apparatus 500 is a normal value or an anomaly by comparing the result value measured by the power and performance measurement apparatus 500 with a result value measured by the system power measurement apparatus 240. When an anomaly occurs in a difference and trend of values, the consistency verification apparatus 266 may find a cause of the anomaly by examining the user program apparatus 261, the neural network hooking apparatus 262, the benchmark driving apparatus 263, and the frequency control apparatus 264, and rebooting the power and performance measurement apparatus 265.

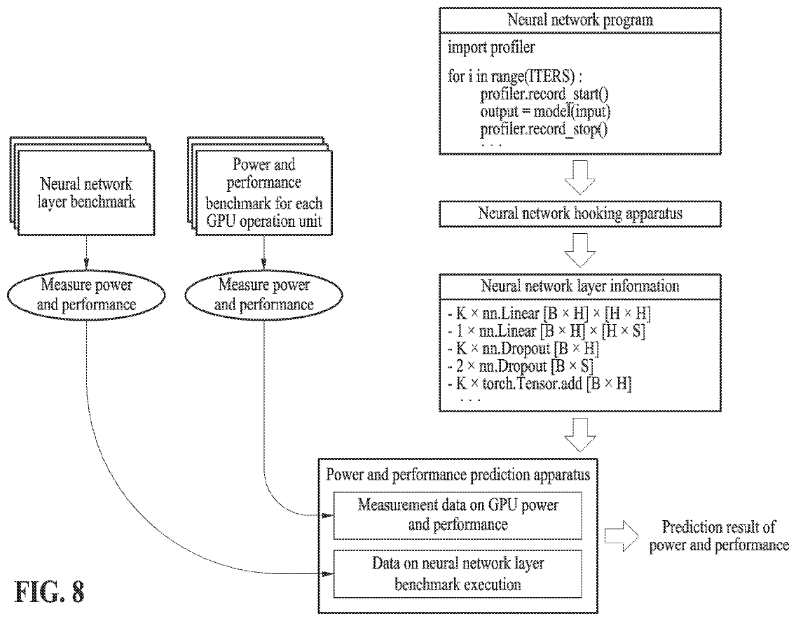

The power and performance prediction apparatus 267 may be an apparatus for predicting a result of power and performance for a newly provided user requirement (analysis requirement information) using GPU hardware information and the result value measured by the power and performance measurement apparatus 265. The power and performance prediction apparatus 267 may build a prediction model based on the GPU hardware information and the result value measured by the power and performance measurement apparatus 265 and may calculate a prediction value through the prediction model. In addition, since feature information of a forward pass and a backward pass may be extracted by the neural network hooking apparatus 262 based on training and inference, the power and performance prediction apparatus 267 may predict power and performance for both training and inference. Even a same layer of a neural network model may have different performance when performing training or inference, for example, in the case of a dropout operation, no operations may be performed during inference. An example of an operating method of the power and performance prediction apparatus 267 is described with reference to FIGS. 8 to 10 shown below.

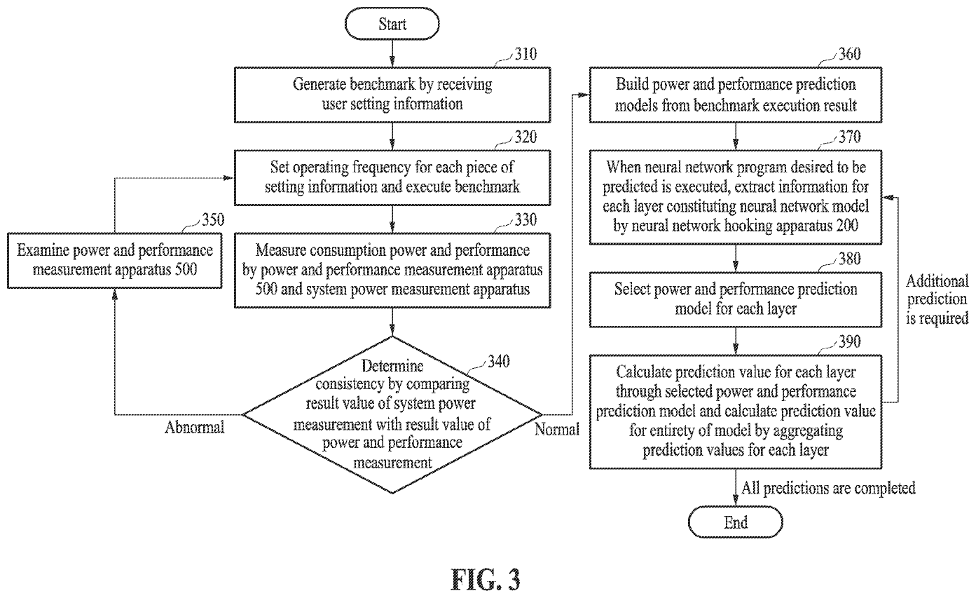

FIG. 3 illustrates an example of an operation of predicting a graphics processing unit (GPU) power and performance by building a GPU power and performance prediction model when a neural network program is executed by a GPU according to one or more embodiments.

Referring to FIG. 3, it is described that operations 310 to 390 are performed using the prediction system shown in FIG. 2. However, operations 310 to 390 may be performed by another suitable electronic device in any suitable system.

Furthermore, the operations of FIG. 3 may be performed in the shown order and manner. However, the order of some operations may be changed, or some operations may be omitted, without departing from the spirit and scope of the shown example. The operations shown in FIG. 3 may be performed in parallel or simultaneously.

For example, an operation of predicting GPU power and performance of a prediction system may include 1) an operation of building a prediction model (hereinafter, also referred to as a “prediction model building operation”) for GPU power and performance prediction and 2) an operation of predicting (hereinafter, also referred to as a “prediction operation”) energy efficiency information and operation performance information respectively corresponding to a plurality of layers configuring an artificial neural network model subject to prediction using the built prediction model. Operations 310 to 360 may relate to the prediction model building operation and operations 370 to 390 may relate to the prediction operation.

In operation 310, a benchmark driving apparatus (e.g., the benchmark driving apparatus 263 of FIG. 2) may receive user setting information and may generate a benchmark. The user setting information may include preset operating frequency information, information on an artificial neural network model subject to benchmark, and information on a component configuring a device.

In operation 320, a frequency control apparatus (e.g., the frequency control apparatus 264 of FIG. 2) may set a core clock frequency and a memory clock frequency based on information set by a user. A benchmark driving apparatus (e.g., the benchmark driving apparatus 263 of FIG. 2) may execute a benchmark based on a set frequency.

In operation 330, power consumption and performance for the executed benchmark may be measured by a power and performance measurement apparatus (e.g., the power and performance measurement apparatus 265 of FIG. 2) and a system power measurement apparatus.

In operation 340, a consistency verification apparatus (e.g., the consistency verification apparatus 265 of FIG. 2) may determine consistency by comparing a result value measured by a system power measurement apparatus (e.g., the system power measurement apparatus 240 of FIG. 2) with a result value measured by the power and performance measurement apparatus.

When the measurement value of the power and performance measurement apparatus is determined to include an anomaly as a result of comparing two measurement values, in operation 350, the consistency verification apparatus may examine user setting information, a neural network hooking apparatus, the benchmark driving apparatus, a frequency control apparatus, and the power and performance measurement apparatus. Thereafter, the prediction system may return to operation 320 and may measure power consumption and performance by executing the benchmark again, and when a result value of measuring the power and performance does not include an anomaly, in operation 360, the prediction system may build power and performance prediction models from the benchmark execution result.

When the power and performance prediction model is built, for a neural network program desired to be predicted, the power and performance prediction apparatus (e.g., the power and performance prediction apparatus 267 of FIG. 2) may predict the power and performance of an operation device (e.g., a GPU) in which the neural network program is executed.

In operation 370, when the neural network program desired to be predicted is executed, information for each layer constituting a neural network model may be extracted by the neural network hooking apparatus (e.g., the neural network hooking apparatus 262 of FIG. 2).

In operation 380, a power and performance prediction model may be selected for each layer by the power and performance prediction apparatus.

In operation 390, the power and performance prediction apparatus may calculate a prediction value for each layer through the power and performance prediction model and may calculate a prediction value for an entirety of the model by aggregating prediction values for each layer. When additional prediction is required, the prediction system may execute the neural network program again and may calculate a prediction value of the entire model.

FIG. 4 illustrates an example of an operation of a benchmark driving apparatus according to one or more embodiments.

Referring to FIG. 4, a benchmark driving apparatus (e.g., the benchmark driving apparatus 263 of FIG. 2) according to one or more embodiments may perform a benchmark generation operation 410, a benchmark execution operation 420, and a benchmark result storage operation 430.

In the benchmark generation operation 410, the benchmark driving apparatus may generate a layer benchmark and a GPU benchmark.

For example, the benchmark driving apparatus may generate a layer benchmark for a layer of the artificial neural network model by receiving a predefined operating frequency and network input information as inputs. The layer benchmark may include a layer benchmark (e.g., a PyTorch DNN layer benchmark) for an artificial neural network model provided by a library and a user-defined DNN layer benchmark.

In addition, by receiving a predefined operating frequency as an input, the benchmark driving apparatus may generate an operation device benchmark (hereinafter, also referred to as a GPU benchmark or a GPU microbenchmark for ease of description) related to a component related to an operation including an SM and a tensor core, and a component related to a memory including a shared memory and L1 cache.

FIG. 5A illustrates an example of benchmark generated by a benchmark driving apparatus according to one or more embodiments.

Referring to FIG. 5A, a layer benchmark 510 may be a layer benchmark generated based on an operating frequency and an input size for a layer. The operating frequency of the benchmark 510 may be one of 500 MHz, 800 MHz, 1100 MHz, and 1400 MHz and (N, M, K) may be a dimension of input data. The layer benchmark may be generated for various layers (e.g., an add layer, a baddbmm layer, a bmm layer, a crossentropy layer, a linear layer, a matmul layer, a dropout layer, an embedding layer, and/or a Gaussian error linear unit (gelu) layer) constituting a neural network.

The GPU benchmark may be generated using a CUDA kernel for each GPU component. For example, referring to the GPU benchmark 520, the benchmark driving apparatus may generate a GPU benchmark kernel by adjusting the number of SMs and the total computation amount of the benchmark with 16 GPU kernels.

Referring to FIG. 4, in the benchmark execution operation 420, the benchmark driving apparatus may execute the generated benchmark and may obtain power consumption and performance for the executed benchmark.

For example, the benchmark driving apparatus may execute the generated benchmark and the power and performance measurement apparatus (e.g., the power and performance measurement apparatus 265 of FIG. 2) may measure a GPU operation count and energy consumed by a GPU for the executed benchmark and may transmit a measurement result to the benchmark driving apparatus. In the benchmark result storage operation 430, the benchmark driving apparatus may store a measurement result. For example, a stored benchmark measurement result may include a layer performance database, a layer operation count database, and a power consumption database.

FIGS. 5B and 5C illustrate examples of measuring power consumption and performance with respect to benchmark according to one or more embodiments.

Referring to FIG. 5B, the power and performance measurement apparatus may measure a GPU operation count using CUPTI. The GPU operation count may be measured by wrapping measurement code on a GPU kernel corresponding to an operation count for each GPU component. Measured performance 530 may be stored as a benchmark result.

Referring to FIG. 5C, the power and performance measurement apparatus may measure GPU energy consumption. For example, the power and performance measurement apparatus may measure the energy consumption of a GPU of NVIDIA using NVNV. NVML may provide a function to measure the power, temperature, and performance of the NVIDIA GPU and control a clock frequency of the GPU. The power and performance measurement apparatus may control the GPU based on the user setting information using NVML and may measure the power and performance of the GPU while the benchmark program is executed.

Prior to executing the benchmark program, the clock frequency of the GPU may be set based on a control value of the frequency control apparatus based on the provided user setting information. The power and performance measurement apparatus may generate and execute a power measurement thread for power measurement. For example, the power measurement thread may measure and record the current power consumption of the GPU by invoking a power measurement application programming interface (API) of NVML library at an interval of 50 ms. The power and performance measurement apparatus may measure and record a timestamp t_s before executing the benchmark program.

The power and performance measurement apparatus may execute the benchmark program for a sufficient period and may terminate the power measurement thread when the benchmark program is terminated. The power and performance measurement apparatus may measure a timestamp t_e immediately after the benchmark program is terminated and may calculate how long it took to execute the benchmark by comparing the value measured before the benchmark program is executed.

The power and performance measurement apparatus may calculate the GPU performance in various methods through the execution time of the benchmark program and a total computation amount of the benchmark program. In addition, a total power consumed by the GPU while the benchmark program is executed may be calculated in various methods using timestamp information before and after execution of the benchmark program and power consumption data of the GPU recorded by the power measurement thread. For example, mensuration by parts may be used to obtain a total computation amount or total power consumption in a limiting value by dividing a measurement time interval into smaller intervals. A measured power consumption 540 may be stored as a benchmark result.

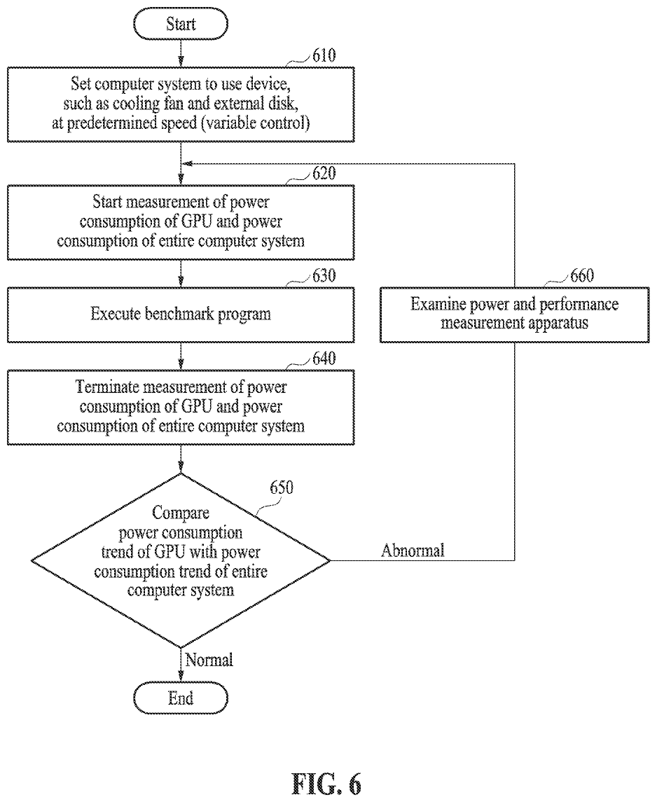

FIG. 6 illustrates an example of a consistency verification method according to one or more embodiments.

Referring to FIG. 6, it is described that operations 610 to 660 are performed using the prediction apparatus 260 shown in FIG. 2. However, operations 610 to 660 may be performed by another suitable electronic device in any suitable system.

Furthermore, the operations of FIG. 6 may be performed in the shown order and manner. However, the order of some operations may be changed or omitted without departing from the spirit and scope of the shown example. The operations shown in FIG. 6 may be performed in parallel or simultaneously.

A consistency verification apparatus (e.g., the consistency verification apparatus 266 of FIG. 2) may be an apparatus for determining whether a result value measured by a power and performance measurement apparatus (e.g., the power and performance measurement apparatus 265 of FIG. 2) is a normal value or an anomaly. The consistency verification apparatus may verify whether a power consumption value of a GPU measured by the power and performance measurement apparatus is abnormal and when a trend and difference of values are abnormal, the consistency verification apparatus may identify a cause of anomaly by examining user setting information, a network hooking apparatus, a benchmark driving apparatus, and a frequency control apparatus.

In operation 610, a prediction apparatus may set a computer system to use a device, such as a cooling fan and an external disk, at a predetermined speed. Since the power consumption of the entire computer system includes the power consumption of various devices, such as a CPU, a cooling fan, and a motherboard, as well as the GPU, control of such components may be important when verifying consistency. Before executing a benchmark program, a device, such as a cooling fan, may need to be set to operate at a fixed speed, and other programs using a CPU or hard disk may not be executed while the benchmark program is executed.

In operation 620, the prediction apparatus may separately measure a power consumption value of the entire computer system equipped with the GPU to verify a power consumption value of the GPU measured by the power and performance measurement apparatus. The power consumption of the entire system may be measured by a system power measurement apparatus (e.g., the system power measurement apparatus 240 of FIG. 2). The system power measurement apparatus may use a power consumption measurement apparatus, such as HIOKI 3334 power meter.

In operation 630, the prediction apparatus may execute the benchmark program and in operation 640, the prediction apparatus may terminate power consumption measurement of the GPU of the power and performance measurement apparatus and the power consumption measurement of the entire computer system of the system power measurement apparatus.

In operation 650, the consistency verification apparatus may determine that an anomaly occurs in the power and performance measurement apparatus of the GPU when a power consumption trend of the GPU is significantly different from a power consumption trend of the entire computer system for a time span in which the benchmark program is executed. An increase in GPU power consumption is significantly greater than an increase in the power consumption of the entire computer system while the benchmark program is executed, the power and performance measurement apparatus of the GPU may need to be examined.

For example, it may be assumed that the power consumption of the entire system when the GPU is not used is A and the power consumption of the entire system when the GPU is used at a maximum capacity is B. The power consumption of the entire system may increase by B−A as the GPU is used at the maximum utilization. When the GPU is used at a half utilization (50% utilization), the power consumption of the entire system may be expected to increase by (B−A)/2. When the power consumption of the entire system changes by a value that is significantly different from the above value, the consistency verification apparatus may determine that the power and performance measurement apparatus may need to be examined. When the GPU utilization is e, the power consumption of the entire system may be expected to increase by (B−A)·e, and the consistency verification apparatus may detect an anomaly of the power and performance measurement apparatus 500 of the GPU based on that value.

FIG. 7 illustrates an example of a neural network hooking apparatus according to one or more embodiments.

Referring to FIG. 7, when a neural network program of a user is executed, a neural network hooking apparatus (e.g., the neural network hooking apparatus 262 of FIG. 2) may extract desired neural network layer information through a hooking module 710 and an information extraction module 720. The neural network hooking apparatus may hook input and output information of a neural network layer through a predefined function list or a separate program added by a user. Extracted input and output information by layer may be automatically input to the prediction model and performance and energy consumption of an entirety of a network may be predicted.

For example, the neural network program may be included in a user program and may be implemented using a neural network library, such as PyTorch. By connecting and executing neural network program code to the neural network hooking apparatus, a user may add the hooking module 710 that extracts desired layer information to the neural network program while minimizing modification of the neural network program.

The hooking module 710 may be a module configured to generate a list of layers constituting a neural network model while the neural network program is executed. For example, when the neural network program is constituted by neural network layers provided by PyTorch, the hooking module 710 may swap layer APIs provided by PyTorch and may cause the layer APIs to pass through the hooking module 710 before code of PyTorch is executed.

While a control flow of the neural network program passes through the hooking module 710, the hooking module 710 may collect and configure a list related to which neural network layer is executed for which input or output. After extracting the required information for configuring the list of layers, the hooking module 710 may pass the control flow of the neural network program to PyTorch to operate the neural network program normally thereafter.

The information extraction module 720 may be a module for extracting required information from the list of layers constituting the neural network model. An information type may include a layer type, a size of an input/output tensor by layer, various parameters, a data type, forward pass information, and backward pass information. The information extraction module 720 may group layers performing the same operation as one and may regard the layers as the same layers. Through this, the time required for the power and performance measurement apparatus to measure performance and power for each layer may be saved.

FIG. 8 illustrates an example of an operation of a power and performance prediction apparatus according to one or more embodiments.

Referring to FIG. 8, the power and performance prediction apparatus (e.g., the power and performance prediction apparatus 267 of FIG. 2) may be an apparatus for predicting a result of power and performance for a newly provided user requirement based on GPU hardware (HW) information and a result value measured by the power and performance measurement apparatus.

The power and performance prediction apparatus may predict the power consumption and performance of a neural network program based on a built prediction model according to training and inference. After extracting information of layers constituting a neural network model through a neural network hooking apparatus (e.g., the neural network hooking apparatus 262 of FIG. 2), the power and performance prediction apparatus may predict GPU power consumption and elapsed time for each layer based on a prediction model. The power and performance prediction apparatus may predict GPU power consumption and elapsed time of an entirety of the neural network model by aggregating prediction values by layers.

The power and performance prediction apparatus may use a result of executing a layer benchmark and a GPU benchmark to constitute the prediction model. While executing the benchmark, the power consumption and performance of the GPU may be measured through the power and performance measurement apparatus. The power and performance prediction apparatus may use a measurement result value as a parameter of the prediction model.

The prediction model may include a performance prediction model and a power consumption prediction model. The performance prediction model for predicting an elapsed time of a neural network layer may be configured as follows: Firstly, the power and performance prediction apparatus may divide a plurality of layers constituting the neural network into a memory-bound layer, which has a relatively small computation amount compared to a memory access amount, and a compute-bound layer, which has a relatively great computation amount compared to a memory access amount.

An elapsed time of the compute-bound layer may be predicted by Equation 1 shown below, for example.

$${T}_{l} = {\sum }_{i} {n}_{l , i} \cdot {α}_{l , i} \cdot {R}_{i} \qquad Equation 1$$

In Equation 1, l may denote a neural network layer, i may denote an operation module of a GPU, n_{l,i} may denote a required computation amount of each operation module in a corresponding layer, α_{l,i} may denote an operation module utilization efficiency of the corresponding layer, and Rᵢ may denote an operating frequency with theoretically best performance among GPU specifications. n_{l,i} may be calculated by extracted layer information, α_{l,i} may be calculated by a neural network layer benchmark execution result, and Rᵢ may be calculated by a specification of the GPU and a GPU execution environment.

An elapsed time of the memory-bound layer may be predicted by Equation 2 shown below, for example.

$${T}_{l} = ( {a}_{l} + {b}_{l} ) \cdot {β}_{l} \cdot B \qquad Equation 2$$

In Equation 2, l may denote a neural network layer, aₗ, bₗ may respectively denote numbers of memory read and write bits, βₗ may denote memory utilization efficiency of a corresponding layer, and B may denote a GPU memory bandwidth. aₗ, bₗ may be calculated by extracted layer information, βₗ may be calculated by a neural network layer benchmark execution result, and B may be calculated by a specification of the GPU and a GPU execution environment.

Power consumptions of the compute-bound layer and the memory-bound layer may be predicted by Equation 3 below, for example.

$${E}_{l} = \{ \begin{matrix}{P}_{static} \cdot {\sum }_{i} {n}_{l , i} \cdot {α}_{l , i} \cdot {R}_{i} + {\sum }_{j} {n}_{l , j} \cdot {e}_{j} if computer bound layer \\ {P}_{static} \cdot ( {a}_{l} + {b}_{l} ) \cdot {β}_{l} \cdot B + {\sum }_{j} {n}_{l , j} \cdot {e}_{j} else if memory bound layer\end{matrix} \qquad Equation 3$$

In Equation 3, l may denote a neural network layer, i, j may denote a GPU component index, P_{static} may denote energy consumption when the GPU is in a static (or idle) state, and eⱼ may denote energy consumption per operation by GPU component. P_{static} and eⱼ may be values obtained by a power and performance benchmark execution result by HW component performing a GPU operation function.

Based on a result value measured by the power and performance measurement apparatus and GPU HW information, Equations 1 to 3 may be calculated and a prediction model may be configured based on Equations 1 to 3. Thereafter, the power and performance prediction apparatus may predict the power and performance of a newly input artificial neural network model using the built prediction model.

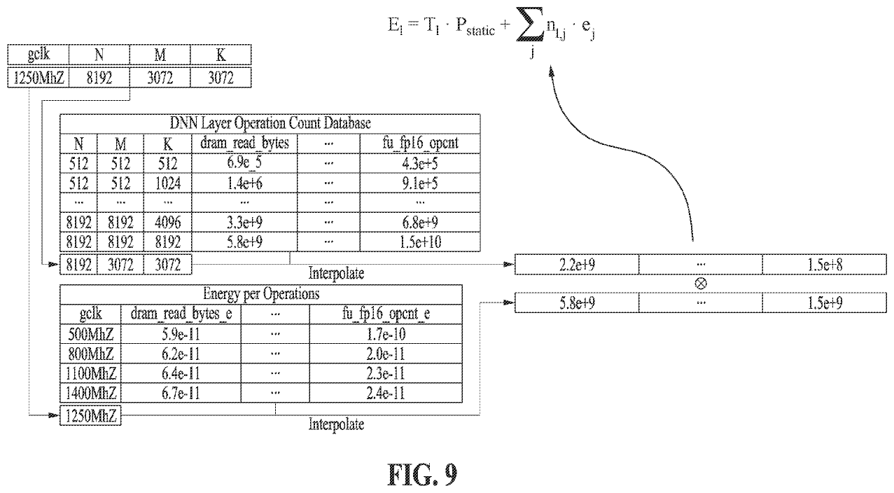

FIG. 9 illustrates an example of a method of predicting the power consumption of an artificial neural network model according to one or more embodiments.

A power and performance prediction apparatus according to one or more embodiments may input layer information obtained through a built prediction model and a network hooking apparatus into a prediction model and may predict operation performance information and energy efficiency information corresponding to each of a plurality of layers.

Referring to FIG. 9, the power and performance prediction apparatus may obtain a size (e.g., 8192, 3072, 3072) of a layer subject to operating frequency (e.g., 1250 MHz) information analysis and may obtain values required to calculate Equation 3 using data generated as a benchmark result. In this case, when values corresponding to the size of the layer and operating frequency information do not exist in the data generated as a benchmark result, the power and performance prediction apparatus may estimate required values using a method, such as interpolation.

The power and performance prediction apparatus may determine whether a layer is a compute-bound layer or a memory-bound layer, and based on the determination that the layer is a memory-bound layer, the power and performance prediction apparatus may predict the power consumption of the memory-bound layer through a P_{static}·(aₗ+bₗ)·βₗ·B+Σⱼn_{l,j}·eⱼ operation.

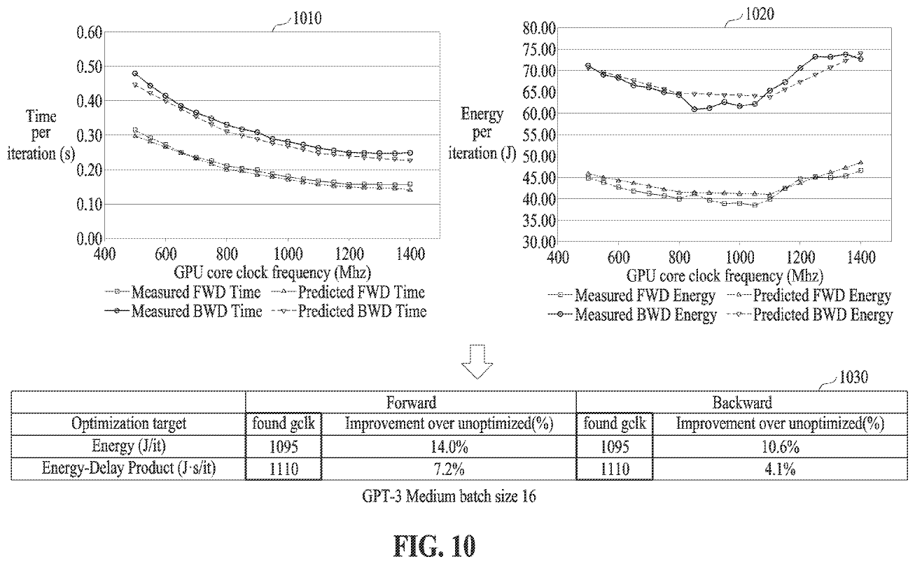

FIG. 10 illustrates an example of a method of determining an optimal operating frequency according to one or more embodiments.

Referring to FIG. 10, a prediction system according to one or more embodiments may find target performance and an optimal operating frequency of a GPU satisfying a constraint based on measurement and prediction results of a neural network model.

For example, the neural network model may be a GPT-3 medium (batch size 16) model and the target performance information may include information on target power consumption and an energy-delay product (EDP), and the constraint may include a maximum GPU clock frequency, a minimum GPU clock frequency, and a time limit for forward and backward iteration.

A graph 1010 may be a graph illustrating measured elapsed times for forward and backward operations and predicted elapsed times for forward and backward operations through a prediction system by candidate frequency. A graph 1020 may be a graph illustrating measured energy consumptions for forward and backward operations and predicted energy consumptions for forward and backward operations through the prediction system by candidate frequency. Referring to the graphs 1010 and 1020, a difference between measured data and predicted data may not be significant.

Referring to a table 1030, the prediction system may determine 1095 MHz to be an optimal GPU operating frequency satisfying the target power consumption and may determine 1110 MHz to be an optimal GPU operating frequency satisfying the target per.

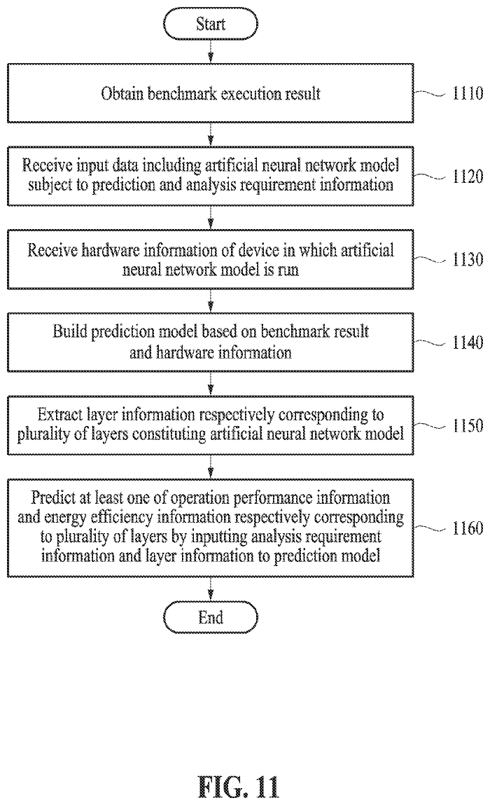

FIG. 11 illustrates an example of a prediction method according to one or more embodiments.

Referring to FIG. 11, it is described that operations 1110 to 1160 are performed using the prediction system shown in FIG. 2. However, operations 1110 to 1160 may be performed by another suitable electronic device in any suitable system.

Furthermore, the operations of FIG. 11 may be performed in the shown order and manner. However, the order of some operations may be changed, or some operations may be omitted, without departing from the spirit and scope of the shown example. The operations shown in FIG. 3 may be performed in parallel or simultaneously.

In operation 1110, a prediction system may obtain a benchmark execution result. The prediction system may receive user setting information, may generate a benchmark based on the user setting information, and may generate a benchmark execution result by executing the benchmark.

The prediction system may receive preset operating frequency information, information on an artificial neural network model subject to the benchmark, and information on a component configuring a device. The prediction system may generate a benchmark based on a size of input data and an operating frequency of a corresponding one of a plurality of layers constituting the artificial neural network model subject to the benchmark. The prediction system may generate the benchmark based on a kernel corresponding to the component configuring the device.

Based on an API, the prediction system may perform a first measurement on operation performance and energy efficiency corresponding to the benchmark, may perform a second measurement on operation performance and energy efficiency corresponding to the benchmark, and may perform consistency determination on results of executing the benchmark by comparing a result of the first measurement and a result of the second measurement.

In operation 1120, the prediction system may receive input data including an artificial neural network model subject to prediction and analysis requirement information.

In operation 1130, the prediction system may receive hardware information of a device in which the artificial neural network model is run.

In operation 1140, the prediction system may build a prediction model based on the benchmark execution result and the hardware information.

In operation 1150, the prediction system may extract layer information respectively corresponding to a plurality of layers constituting the artificial neural network model. The prediction system may extract input data information and output data information respectively corresponding to the plurality of layers.

In operation 1160, the prediction system may input analysis requirement information and the layer information to the prediction model and may predict at least one of operation performance information and energy efficiency information respectively corresponding to the plurality of layers.

The prediction system may predict the energy efficiency information and the operation performance information respectively corresponding to the plurality of layers for each component configuring a device.

The prediction system may determine a weight between a computation amount and a memory access amount in a corresponding layer for each of the plurality of layers and may predict the operation performance information and the energy efficiency information respectively corresponding to the plurality of layers.

The prediction system may classify the plurality of layers into a compute-bound layer or a memory-bound layer, and based on a classification result, the prediction system may predict the operation performance information and the energy efficiency information respectively corresponding to the plurality of layers.

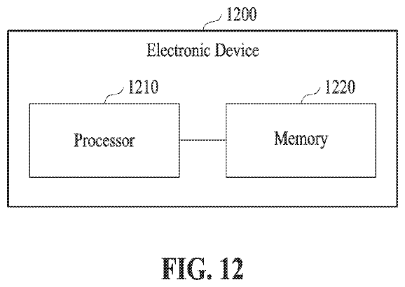

FIG. 12 illustrates an example of a configuration of an electronic device according to one or more embodiments.

Referring to FIG. 12, an electronic device 1200 may include a processor 1210 (e.g., one or more processors) and a memory 1220 (e.g., one or more memories). The memory 1220 may be connected to the processor 1210 and may store instructions executable by the processor 1210, data to be operated by the processor 1210, or data processed by the processor 1210. The memory 1220 may include a non-transitory computer readable medium, for example, a high-speed random-access memory (RAM), and/or a non-volatile computer readable storage medium (e.g., one or more disk storage devices, flash memory devices, or other non-volatile solid state memory devices). For example, the memory 1220 may include a non-transitory computer-readable storage medium storing instructions that, when executed by the processor 1210, configure the processor 1210 to perform any one, any combination, or all of the operations and methods described herein with reference to FIGS. 1-11. The electronic device 1200 may be implemented as at least one of a mobile device, such as a mobile phone, a smart phone, a personal digital assistant (PDA), a netbook, a tablet computer, and/or a laptop computer, a wearable device, such as a smart watch, a smart band, and/or smart glasses, a home appliance, such as a television (TV), a smart TV, and/or a refrigerator, a security device, such as a door lock, and/or a vehicle, such as an autonomous vehicle, and/or a smart vehicle.

The processor 1210 may execute the instructions to perform the operations described with reference to FIGS. 1 to 11. The processor 1210 may include any one or any combination of any two or more of the prediction apparatus 10, the benchmark driving apparatus 110, the neural network hooking apparatus 120, the power and performance prediction apparatus 130, the CPU 210, the main memory 220, the GPU 230, the system power measurement apparatus 240, the interface module 250, the prediction apparatus 260, the user program apparatus 261, the neural network hooking apparatus 262, the benchmark driving apparatus 263, the frequency control apparatus 264, the power and performance measurement apparatus 265, the consistency verification apparatus 266, the power and performance prediction apparatus 267, the hooking module 710, and the information extraction module 720 described herein with respect to FIGS. 1 to 11.

In addition, the descriptions provided with reference to FIGS. 1 to 11 may apply to the electronic device 1200.

The prediction apparatuses, benchmark driving apparatuses, neural network hooking apparatuses, power and performance prediction apparatuses, CPUs, main memories, GPUs, system power measurement apparatuses, interface modules, one or more user programs devices, frequency control apparatuses, power and performance measurement apparatuses, consistency verification apparatuses, hooking modules, information extraction modules, electronic devices, processors, memories, prediction apparatus 10, benchmark driving apparatus 110, neural network hooking apparatus 120, power and performance prediction apparatus 130, CPU 210, main memory 220, GPU 230, system power measurement apparatus 240, interface module 250, prediction apparatus 260, user program apparatus 261, neural network hooking apparatus 262, benchmark driving apparatus 263, frequency control apparatus 264, power and performance measurement apparatus 265, consistency verification apparatus 266, power and performance prediction apparatus 267, hooking module 710, information extraction module 720, electronic device 1200, processor 1210, memory 1220, and other apparatuses, devices, units, modules, and components disclosed and described herein with respect to FIGS. 1-11 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
obtaining a benchmark execution result;
receiving input data comprising a neural network model subject to prediction and analysis requirement information;
receiving information on hardware of a device in which the neural network model is run;
building a prediction model based on the benchmark execution result and the hardware information;
extracting layer information respectively corresponding to a plurality of layers configuring the neural network model; and
predicting either one or both of operation performance information and energy efficiency information respectively corresponding to the plurality of layers by inputting the analysis requirement information and the layer information to the prediction model.

2. The method of claim 1, wherein the predicting comprises predicting the operation performance information and the energy efficiency information respectively corresponding to the plurality of layers for each component configuring the device.

3. The method of claim 1, wherein the predicting comprises:
for each of the plurality of layers, determining a weight between a computation amount and a memory access amount in a layer; and
predicting the operation performance information and the energy efficiency information respectively corresponding to the plurality of layers based on the weight.

4. The method of claim 1, wherein the predicting comprises:
classifying the plurality of layers into either one of a compute-bound layer and a memory-bound layer; and
predicting the operation performance information and the energy efficiency information respectively corresponding to the plurality of layers based on a result of the classifying.

5. The method of claim 1, wherein the extracting of the layer information comprises extracting input data information and output data information respectively corresponding to the plurality of layers.

6. The method of claim 1, wherein the obtaining of the benchmark execution result comprises:
receiving user setting information;
generating a benchmark based on the user setting information; and
generating the benchmark execution result by executing the benchmark.

7. The method of claim 6, wherein the receiving of the user setting information comprises receiving information on a preset operating frequency, information on a neural network model subject to benchmark, and information on a component configuring the device.

8. The method of claim 7, wherein the generating of the benchmark comprises, for each of the plurality of layers configuring the neural network model subject to the benchmark, generating the benchmark based on an input data size and an operating frequency of a layer.

9. The method of claim 7, wherein the generating of the benchmark comprises generating the benchmark based on a kernel corresponding to a component configuring the device.

10. The method device of claim 1, wherein the generating of the benchmark execution result comprises:
performing a first measurement on operation performance and energy efficiency corresponding to the benchmark based on an application programming interface (API);
performing a second measurement on operation performance and energy efficiency corresponding to the benchmark using an external device; and
performing consistency determination on the benchmark execution result by comparing a result of the first measurement and a result of the second measurement.

11. A non-transitory computer-readable storage medium storing instructions that, when executed by one or more processors, configure the one or more processors to perform the method of claim 1.

12. An apparatus comprising:
one or more processors configured to:
obtain a benchmark execution result;
receive input data comprising a neural network model subject to prediction and analysis requirement information;
receive information on hardware of a device in which the neural network model is run;
build a prediction model based on the benchmark execution result and the hardware information;
extract layer information respectively corresponding to a plurality of layers configuring the neural network model; and
predict either one or both of operation performance information and energy efficiency information respectively corresponding to the plurality of layers by inputting the analysis requirement information and the layer information to the prediction model.

13. The apparatus of claim 12, wherein, for the predicting, the one or more processors are further configured to predict the operation performance information and the energy efficiency information respectively corresponding to the plurality of layers for each component configuring the device.

14. The apparatus of claim 12, wherein, for the predicting, the one or more processors are further configured to:
for each of the plurality of layers, determine a weight between a computation amount and a memory access amount in a layer; and
predict the operation performance information and the energy efficiency information respectively corresponding to the plurality of layers based on the weight.

15. The apparatus of claim 12, wherein, for the predicting, the one or more processors are further configured to:
classify the plurality of layers into a compute-bound layer or a memory-bound layer; and
predict the operation performance information and the energy efficiency information respectively corresponding to the plurality of layers based on a classification result.

16. The apparatus of claim 12, wherein, for extracting of the layer information, the one or more processors are further configured to extract input data information and output data information respectively corresponding to the plurality of layers.

17. The apparatus of claim 12, wherein, for the obtaining of the benchmark execution result, the one or more processors are further configured to:
receive user setting information;
generate a benchmark based on the user setting information; and
generate the benchmark execution result by executing the benchmark.

18. The apparatus of claim 17, wherein, for the receiving of the user setting information, the one or more processors are further configured to receive information on a preset operating frequency, information on a neural network model subject to benchmark, and information on a component configuring the device.

19. The apparatus of claim 18, wherein, for the generating of the benchmark, the one or more processors are further configured to, for each of the plurality of layers configuring the neural network model subject to the benchmark, generate the benchmark based on an input data size and an operating frequency of a layer.

20. The apparatus of claim 18, wherein, for the generating of the benchmark execution result, the one or more processors are further configured to:
perform a first measurement on performance and energy efficiency;
perform a second measurement on operation performance and energy efficiency corresponding to the benchmark using an external device; and
perform consistency determination on the benchmark execution result by comparing a result of the first measurement and a result of the second measurement.
